(19) United States
(12) Patent Application Publication
(10) Pub. No.: US 2009/0261271 A1
(43) Pub. Date: Oct. 22, 2009

(54) SAMPLE OBSERVING METHOD AND MICROSCOPE

(76) Inventor: Yoshinori Iketaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/309,440

(22) PCT Filed: Jul. 2, 2007
(86) PCT No.: PCT/JP2007/063245

§ 371 Date: Jan. 16, 2009

(30) Foreign Application Priority Data
Jul. 19, 2006 (JP) 2006-196943

(51) Int. Cl. G01N 21/00; G02B 21/06; G01J 3/46

(52) U.S. Cl. 250/473.1; 359/385; 356/402

(57) ABSTRACT

A method for observing a sample containing photochromic molecules having a quantum state of at least a first stable state S0 and a second stable state S3. Used are first light for exciting the photochromic molecules from the first stable state S0 to a first excited state S1 enabling optical response, and second light for exciting the photochromic molecules from the first excited state S1 to a second excited state S2 of another energy level. The sample is irradiated with the first light and the second light partly overlapping each other so that the photochromic molecules in the region irradiated with the overlapping first and second lights are transformed through the second excited state S2 to the second stable state S3, and the photochromic molecules in the region irradiated with the first light only are transformed to the first excited state S1, thereby observing the sample.

### CROSS-REFERENCE OF RELATED APPLICATION

The present application is claiming the priority based on the Japanese Patent Application No. 2006-196,943 filed on Jul. 19, 2006. The whole disclosure of the original application is incorporated herein for reference.

### TECHNICAL FIELD

This invention relates to a method for observing a sample and a microscope, and more particularly to a method and a microscope for observing a sample containing photochromic molecules with super-resolution by irradiating the sample with first light and second light.

### RELATED ART

The technique of optical microscopes has an old history during which various types of microscopes have been developed. In recent years, moreover, as peripheral technologies such as laser technology and electronic imaging technology have been advanced, even higher-performance microscopic systems have been developed.

In such a background, high-performance microscopes have been proposed which use the double resonance absorption process generated by illuminating a sample with lights of a plurality of wavelengths to enable controlling of contrast of obtained images and chemical analyses as well (refer to, for example, Japanese Patent Application Laid Open No. H08-184, 552).

With such microscopes, the double resonance absorption is used to select particular molecules to observe absorption and fluorescence caused by particular optical transition. This principle will be explained with reference to FIGS. 7 to 10. FIG. 7 illustrates electron structures of valence orbits of molecules constituting a sample. First, the electrons of the valence orbits of the molecules in the ground state (state S0) shown in FIG. 7 are excited by a light of wavelength λ1 to be changed to a first electronically-excited state (State S1) shown in FIG. 8. Then, the molecules are excited by the other light of wavelength λ2 in the similar manner to be changed to a second electronically excited state (state S2) shown in FIG. 9. The molecules in this excited state generate fluorescence or phosphorescence to be returned to the ground state as shown in FIG. 10.

In the microscopy using the double resonance absorption process, absorption images and luminescent images are observed using the absorbing process in FIG. 9 and the emissions of fluorescence and phosphorescence in FIG. 10. In this microscopy, at the beginning the molecules constituting the sample are excited with the light of resonant wavelength λ1 by means of laser beams or the like to the state S1 as in FIG. 8. In this case, the number of molecules in the state S1 in a unit volume increases as the irradiated light intensity increases.

At this point, as the linear absorption coefficient is obtained by product of the absorption cross-section per one molecule and the number of molecules per unit volume, the linear absorption coefficient regarding the resonant wavelength λ2 subsequently irradiated depends on the intensity of the light of wavelength λ1 initially irradiated in the exciting process as shown in FIG. 9. In other words, the linear absorption coefficient regarding the wavelength λ2 can be controlled by the intensity of the light of wavelength λ1. This indicates that a sample is irradiated with the lights of different wavelengths λ1 and λ2, and the transmission image generated by the wavelength λ2 is photographed, thereby enabling the contrast of the transmission image to be completely controlled by means of the light of the wavelength λ1.

In the case that the deexcitation process by the fluorescence or phosphorescence is possible in the excited state as shown in FIG. 9, its emission intensity is proportional to the number of the molecules in the state S1. In the case utilizing it as a fluorescence microscope, therefore, it is also possible to control the image contrast.

In the microscopy using the double resonance absorption process, moreover, it becomes possible not only to control the image contrast as described above but also to perform the chemical analysis. In other words, as the outermost shell electron orbits shown in FIG. 7 have energy levels inherent in the respective molecules, the wavelength λ1 is different from each individual molecule, and at the same time, the wavelength λ2 is also inherent in each of the molecules.

At this moment, even with the illumination of single wavelength of the prior art, to some extent it is possible to observe absorption images or fluorescent images of particular molecules, but it is impossible to accurately identify the chemical compositions of the sample, because regions of wavelengths of absorption bands in some molecules are generally overlapped.

In contrast herewith, with the microscopy using the double resonance absorption process, it becomes possible to more accurately identify chemical compositions, because molecules which absorb or emit light are limited with two wavelengths of λ1 and λ2, in comparison with the prior art methods. In case that valency electrons are excited, moreover, as only lights having particular electric field vectors with respect to molecular axes are strongly absorbed, after polarization directions of the wavelengths λ1 and λ2 are determined, by photographing absorption images or fluorescent images it becomes possible to identify directions of orientation even for the same molecules.

In recent years, further, a fluorescence microscope has been proposed which has a high spatial resolution exceeding the diffraction limit using double resonance absorption process (refer to, for example, Japanese Patent Application Laid Open No. 2001-100,102).

FIG. 11 is a conceptual diagram of the double resonance absorption process in molecules, which shows an aspect that molecules in the ground state S0 are excited by the light of wavelength λ1 to the first electronically excited state S1, and further excited by the second light of wavelength λ2 to the second electronically excited state S2. Moreover, FIG. 11 illustrates that the fluorescence from some kinds of molecules in the second electronically excited state S2 is extremely weak.

In the case of the molecules having an optical property as shown in FIG. 11, a very interesting phenomenon occurs. FIG. 12 is a conceptual diagram of the double resonance absorption process like FIG. 11. In FIG. 12, the x axis of abscissa indicates broadening of spatial distance, and shown are space domains A1 irradiated with the light of wavelength λ2 and a space domain A0 not irradiated with the light of wavelength λ2.

In FIG. 12, a number of molecules in the state S1 are produced by exciting with the light of wavelength λ1 in the space domain A0, on that occasion fluorescence emitting light of wavelength λ3 from the space domain A0 can be seen. In the space domain A1, however, most of the molecules in the state S1 are immediately excited to the higher state S2 by irradiating with the light of wavelength λ2 so that there are no molecules in the state S1 in the space domain A1. Such a phenomenon is confirmed with several kinds of molecules. Consequently, the fluorescence of wavelength λ3 is completely eliminated in the space domain A1, and the fluorescence from the state S2 does not exist originally so that in the space domain A1, the fluorescence itself is completely restrained (fluorescence restrictive effect), with the result that the fluorescence is emitted only from the space domain A0.

This fact has important implications from a viewpoint of application fields of the microscope. In other words, with the prior art scanning laser microscopes and the like, laser beams are focused by collecting lens into microbeams by means of which a sample is scanned, on that occasion the size of the microbeams provides a limitation of diffraction determined by numerical apertures of the collecting lens and wavelength so that any more spatial resolution cannot be essentially expected.

In contrast herewith, in the case of FIG. 12, two kinds of lights of wavelength λ1 and λ2 are spatially overlapped skillfully to restrain the fluorescence regions by irradiating the light of wavelength λ2 so that upon noticing the region irradiated with, for example, the light of wavelength λ1, the fluorescence regions can be scaled down to be smaller than the limitation of diffraction determined by numerical apertures of the collecting lens and wavelength, thereby enabling the spatial resolution to be substantially improved. The light of wavelength λ1 is called “pump light” and the light of wavelength λ2 is called “erase light” in addition to their original names hereinafter. By utilizing this principle, therefore, it becomes possible to realize a super-resolution microscope, for example, a super-resolution fluorescence microscope using the double resonance absorption process exceeding the diffraction limit.

In recent years, moreover, a super-resolution technique has been proposed, which uses biologically interesting photochromic molecules as a probe. These molecules are transformed from a first stable state having fluorescent emission characteristics to a second stable state having no fluorescent emission characteristics by light stimulation of particular wavelengths (photoisomerization). Moreover, the photoisomerization occurs by breaking or bonding a particular chemical binding or causing charge transfer as processes of other transformations. Basically, if the photoisomerization occurs, the molecular structure is completely changed so that the optical properties are also changed.

For example, if the fluorescence protein FP595 having a photochromic region in the first stable state is irradiated with a yellow light of wavelength of about 595 nm, red fluorescence of a longer wavelength region is emitted. However, if this fluorescence protein FP595 is irradiated with light of short wavelength less than 458 nm, it is transformed to the second stable state so that the optical property is completely changed, with the result that if the yellow light is irradiated, fluorescence is no longer emitted. Once transformed to the second stable state, its state is so stable that it is not restored to the first stable state for a short period of time unless energy excitement is forcedly applied externally.

The super-resolution technique using photochromic molecules as the probe tends to utilize the characteristics of the photochromic molecules described above as a kind of fluorescence-suppression effect and is expected to be applicable to biological microscopes.

With the super-resolution technique regarding the photochromic molecules reported heretofore, however, as the optical realization of the fluorescence-suppression effect is inferior, there has been a problem that the realization of the super-resolution effect is inferior to the double resonance absorption process. Moreover, as the photoisomerization is slow, the fluorescence-suppression and the return to the first stable state are slow so that the measurement time increases.

These facts will be explained hereinafter. FIG. 13 (a) illustrates a spectral diagram of a super-resolution method using the double resonance absorption process of the prior art, and FIG. 13 (b) shows a spectral diagram of a super-resolution method utilizing the fluorescence-suppression effect of photochromic molecules. The abscissa axis shows internuclear separation, and ordinate axis shows excitation energy.

In the super-resolution method using the double resonance absorption process, as shown in FIG. 13 (a) molecules in a ground state (S0) are irradiated with pump light of photon energy E21 to be excited to the first excited state (S1) enabling fluorescence emission, and for the purpose of fluorescence-suppression, the molecules are further irradiated with erase light of photon energy E22 to be transformed to higher order excited state (S3), in which state the fluorescence is suppressed by means of thermal relaxation. At this time, the photoreactive processes are all effected at very high speeds of subnanosecond.

In contrast herewith, the photochromic molecules have two metastable potentials of local minimum corresponding to the first stable state (S0) and the second stable state (S3) as shown in FIG. 13 (b). In the super-resolution method utilizing the fluorescence-suppression effect of photochromic molecules, therefore, in general the photochromic molecules in the ground state (S0) which is the first stable state are irradiated with pump light of photon energy E31 to be excited to the first excited state (S1) enabling the fluorescence to be emitted, and further irradiated with erase light of photon energy E32 exceeding the barrier energy Et absolutely necessary for the transformation from the first stable state (S0) to the second stable state (S3) so that the molecules are caused to transform to the higher order second excited state (S2) and to pass through the second excited state (S2), thereby enabling the molecules to be transformed to the second stable state (S3).

In this case, however, concerning the intensity of the erase light for the transformation to the second stable state (S3), if the intensity is too high, even once they are transformed from the first stable state (S1) to the second stable state (S3), they are excited again by the erase light to return to the first stable state (S1) and are excited again by the pump light to emit the fluorescence so as to produce residual fluorescent components.

This phenomenon signifies that the fluorescence-suppression cannot be securely induced even if the intensity of the erase light is higher, and this fact has an undesirable effect on the image formation performance of the super-resolution method. In this regard, a further explanation will be continued with reference to the two-dimensional point image distribution function shown in FIG. 14.

In the super-resolution method, a sample is irradiated with a pump light of gaussian type and an erase light spatially coaxially aligning with the pump light and having a doughnut shape cross-section in a plane perpendicular to its optical axis. On this occasion, in the case using the double resonance absorption process, as the fluorescence is completely suppressed in the periphery of the pump light where the intensity of the erase light is sufficient, the obtained fluorescent spot pattern, that is, two-dimensional point image distribution function becomes a very narrow Lorentz type function as shown by a symbol I in FIG. 14.

In contrast, in the case utilizing the fluorescence-suppression effect of photochromic molecules, even if the intensity of the erase light is increased, the fluorescence-suppression could not be securely induced so that the fluorescence-suppression in the periphery of the pump light becomes insufficient.

Consequently, the obtained two-dimensional point image distribution function becomes of a function form in that contractions of spot size occur only at its apex, and the fluorescence-suppression could not be sufficiently spatially performed at the lower portions of the curve as shown by a symbol II in FIG. 14. A symbol III in FIG. 14 shows a two-dimensional point image distribution function of the pump light.

### DISCLOSURE OF THE INVENTION

Therefore, the invention achieved in view of these problems of the prior art has an object to provide a sample observing method and a microscope enabling a sample containing photochromic molecules to be observed with a super-resolution by securely inducing a fluorescence suppression effect without producing any residual fluorescent component.

The first aspect of the invention, which achieves the object described above, is a method for observing a sample containing photochromic molecules having a quantum state of at least a first stable state S0 and a second stable state S3,

wherein first light and second light are used, said first light for exciting said photochromic molecules from said first stable state S0 to a first excited state S1 enabling optical response, and said second light for exciting said photochromic molecules from said first excited state S1 to a second excited state S2 of another energy level are used, and
wherein said sample is irradiated with said first light and said second light partly overlapping each other so that said photochromic molecules in the region irradiated with said overlapping first and second lights are transformed through said second excited state S2 to said second stable state S3, and said photochromic molecules in the region irradiated with said first light only are transformed to said first excited state S1, thereby observing said sample.

Moreover, the second aspect of the invention, which achieves the object described above, is a microscope for observing a sample containing photochromic molecules having a quantum state of at least a first stable state S0 and a second stable state S3,

said microscope comprising:
a first light source for emitting first light for exciting said photochromic molecules from said first stable state S0 to a first excited state S1 enabling optical response,
a second light source for emitting second light for exciting said photochromic molecules from said first excited state S1 to a second excited state S2 of another energy level,
an optical system for partly overlapping said first light and said second light and focusing the overlapping lights on said sample so as to irradiate said sample with the overlapping lights,
a scan section for scanning said sample by relatively moving said sample and the lights emitted through said optical system so that said photochromic molecules in the region irradiated with said overlapping first and second lights by said optical system are transformed through said second excited state S2 to said second stable state S3, and said photochromic molecules in the region irradiated with said first light only are transformed to said first excited state S1, and
a detecting section for detecting optical response generated from said photochromic molecules excited to said first excited state S1.

The third aspect of the invention resides in the microscope according to the second aspect, wherein the following relation is satisfied;

E2<E1<Et<E1+E2, and E1<Ec

where E1: photon energy of said first light, E2: photon energy of said second light, Et: barrier energy when said photochromic molecules are transformed from said first stable state S0 to said second stable state S3, and Ec: barrier energy when said photochromic molecules are transformed from said second stable state S3 to said first stable state S0.

The fourth aspect of the invention resides in the microscope according to the second aspect, wherein irradiation timing of said first light and said second light is so controlled that the irradiation of said second light is started, while relaxation of said photochromic molecules exited to said first excited state S1 by the irradiation of said first light has not started yet.

The fifth aspect of the invention resides in the microscope according to the second aspect, wherein irradiation timing of said first light and said second light is so controlled that at respective points to be observed said first light and said second light are irradiated and then said first light only is irradiated, and further the optical response generated from said photochromic molecules by the irradiation of said first light only is detected in said detecting section.

The sixth aspect of the invention resides in the microscope according to the second aspect, wherein said microscope further comprises a third light source for emitting third light having photon energy larger than barrier energy Ec when said photochromic molecules are transformed from said second stable state S3 to said first stable state S0, and after the detection of the optical response generated from said photochromic molecules at respective points to be observed, said respective points are irradiated with said third light through said optical system to restore said photochromic molecules in said second stable state S3 to said first stable state S0.

The seventh aspect of the invention resides in the microscope according to the third aspect, wherein irradiation timing of said first light and said second light is so controlled that the irradiation of said second light is started, while relaxation of said photochromic molecules excited to said first excited state S1 by the irradiation of said first light has not started yet.

The eighth aspect of the invention resides in the microscope according to the third aspect, wherein irradiation timing of said first light and said second light is so controlled that at respective points to be observed said first light and said second light are irradiated and then said first light only is irradiated, and further the optical response generated from said photochromic molecules by the irradiation of said first light only is detected in said detecting section.

The ninth aspect of the invention resides in the microscope according to the third aspect, wherein said microscope further comprises a third light source for emitting third light having photon energy larger than barrier energy Ec when said photochromic molecules are transformed from said second stable state S3 to said first stable state S0, and after the detection of the optical response generated from said photochromic molecules at respective points to be observed, said respective points are irradiated with said third light through said optical system to restore said photochromic molecules in said second stable state S3 to said first stable state S0.

The tenth aspect of the invention resides in the microscope according to the fourth aspect, wherein irradiation timing of said first light and said second light is so controlled that at respective points to be observed said first light and said second light are irradiated and then said first light only is irradiated, and further optical response generated from said photochromic molecules by the irradiation of said first light only is detected in said detecting section.

The eleventh aspect of the invention resides in the microscope according to the fourth aspect, wherein said microscope further comprises a third light source for emitting third light having photon energy larger than barrier energy Ec when said photochromic molecules are transformed from said second stable state S3 to said first stable state S0, and after the detection of the optical response generated from said photochromic molecules at respective points to be observed, said respective points are irradiated with said third light through said optical system to restore said photochromic molecules in said second stable state S3 to said first stable state S0.

The twelfth aspect of the invention resides in the microscope according to the fifth aspect, wherein said microscope further comprises a third light source for emitting third light having photon energy larger than barrier energy Ec when said photochromic molecules are transformed from said second stable state S3 to said first stable state S0, and after the detection of the optical response generated from said photochromic molecules at respective points to be observed, said respective points are irradiated with said third light through said optical system to restore said photochromic molecules in said second stable state S3 to said first stable state S0.

FIG. 1 illustrates a spectral diagram of photochromic molecules for explaining the principle of the present invention. Without directly transforming photochromic molecules from the first stable state to the second stable state by means of the erase light as is the case with the prior art, according to the invention the photochromic molecules are irradiated with first light and second light of two colors so as to induce the double resonance absorption so that the photochromic molecules are transformed from the first stable state to the second stable state.

For this purpose, first, photochromic molecules in the ground state (S0) which is the first stable state are irradiated with the first light (pump light) of photon energy E1 so as to be excited and transformed to the first excited state (S1) enabling optical response. When the molecules have been transformed to this first excited state (S1), usually the photochromic molecules are decayed to the ground state (S0) by optical response process.

According to the invention, while the first excited state (S1) has not been decayed yet, the second light (erase light) of photon energy E2 is irradiated to cause the photochromic molecules to be excited and transformed from the first excited state (S1) to the second excited state (S2) of higher quantum level than the first excited state (S1). In this case, necessary conditions are that the photon energy E2 when transforming to the second excited state (S2) is more than the barrier energy Et absolutely necessary for transforming from the first stable state (S0) to the second stable state (S3), and even when the photochromic molecules in the second stable state (S3) are irradiated with the pump light and erase light, the double resonance absorption does not occur.

For this reason, the present invention is based on the recognition of the fact that when the photochromic molecules are transformed from the first stable state (S0) to the second stable state (S3), their molecular structure changes and hence their optical properties also change. According to the invention the photon energies E1 and E2 of the respective lights are so set that the photochromic molecules in the second stable state (S3) do not fulfill the resonance conditions for the double resonance absorption by the excitation effected by the pump light and the erase light. In this way, the transformation from the second stable state (S3) to the first stable state (S0) by the irradiation of the pump light and the erase light does not occur so that no residual fluorescent component produces. Of course, the molecules in the second stable state (S3) cannot be excited by single excitation of the pump light or the erase light and therefore the fluorescent emission does not occur.

In order to securely preclude the transformation from the second stable state (S3) to the first stable state (S0), moreover, according to a preferable embodiment of the invention the energy interval of between quantum states of selected photochromic molecules is determined so as to fulfill the following conditions.

(1) As a major premise, the photon energy E1 of the pump light for exciting the photochromic molecules in the first stable state (S0) to the first excited state (S1) enabling the optical response is such an energy which does not transform the molecules from the first stable state (S0) to the second stable state (S3). In other words, the photon energy E1 is smaller than the barrier energy Et required to transform the first stable state (S0) to the second stable state (S3).

(2) The sum of the photon energy E1 of the pump light and the photon energy E2 of the erase light for exciting the photochromic molecules to the second excited state (S2) is at least larger than the barrier energy Et required to transform from the first stable state (S0) to the second stable state (S3).

(3) In order to prohibit the generation of the residual fluorescent components, that is, to prevent the photochromic molecules transformed to the second stable state (S3) from returning from the second stable state (S3) to the first stable state (S0), the photon energy E1 of the pump light is smaller than the barrier energy Ec required to transform from the second stable state (S3) to the first stable state (S0).

The conditions described above are summarized as follows.

E2<E1<Et<E1+E2, and E1<Ec

In addition, it is absolutely necessary to start irradiating the erase light while the photochromic molecules excited to the S1 state by irradiating the pump light have not been decayed yet. Because, if the irradiation of the pump light has been stopped and the photochromic molecules has been decayed to the ground state (S0) which is the first stable state, the photon energy E2 of the erase light becomes remarkably smaller than the barrier energy Et so that the photochromic molecules cannot be effectively transformed from the first stable state (S0) to the second stable state (S3) by irradiating the erase light.

If a sample containing the photochromic molecules is irradiated with the pump light and the erase light spatially overlapping each other in a manner that the above conditions are fulfilled, the photochromic molecules in the portion irradiated with the pump light and the erase light are transformed to the second stable state (S3), which do not emit the fluorescence even if being excited by the pump light. In contrast herewith, the photochromic molecules which have not been irradiated with the erase light cannot exceed the barrier energy Et so that the intensity in the fluorescent region required to be observed is not impaired.

### BRIEF DESCRIPTION OF THE DRAWINGS

FIG. 1 is a spectral diagram of photochromic molecules for explaining the principle of the invention;

FIG. 2 is a block diagram of main parts of the optical system of the super-resolving microscope according to the first embodiment of the invention;

FIG. 3 is an enlarged plan view illustrating a phase plate in FIG. 2;

FIG. 4 is a timing chart illustrating the irradiating timing of pump light and erase light in the super-resolving microscope according to the second embodiment of the invention;

FIG. 5 is a block diagram of main parts of the optical system of the super-resolving microscope according to the third embodiment of the invention;

FIG. 6 is a timing chart illustrating the irradiating timing of pump light, erase light, and return light in the super-resolving microscope according to the third embodiment of the invention;

FIG. 7 is a conceptual diagram illustrating an electron structure of valence orbits of molecules constituting a sample;

FIG. 8 is a conceptual diagram illustrating first excited state of molecules in FIG. 16;

FIG. 9 is a conceptual diagram illustrating second excited state of the molecules;

FIG. 10 is a conceptual diagram illustrating a state returning from the second excited state to the ground state;

FIG. 11 is a conceptual diagram for explaining double resonance absorption process of molecules;

FIG. 12 is also a conceptual diagram for explaining double resonance absorption process;

FIGS. 13 (a) and (b) are spectral diagrams of super-resolving method using double resonance absorption process, and of super-resolving method utilizing fluorescence-suppression effect of photochromic molecules, respectively; and

FIG. 14 is a view illustrating two dimensional point image distribution functions of the super-resolving method using the double resonance absorption process and the super-resolving method utilizing the fluorescence-suppression effect of photochromic molecules.

### BEST MODE FOR CARRYING OUT THE INVENTION

### First Embodiment

In the present embodiment, samples containing fluorescence protein FP595 as photochromic molecules are observed. The fluorescence protein FP595 has the following characteristics. When the fluorescence protein FP595 in a first stable state (S0) is irradiated with light of wavelength 568 nm (pump light), it exhibits a peak of fluorescent emission at wavelength 605 nm, while when the fluorescence protein is irradiated with light of wavelength 458 nm (erase light), it gets over barrier energy and is transformed to a second stable state (S3). Once it has been transformed to the second stable state (S3), it does not emit fluorescence even if irradiating with the pump light, but it emits fluorescence by irradiating with the erase light.

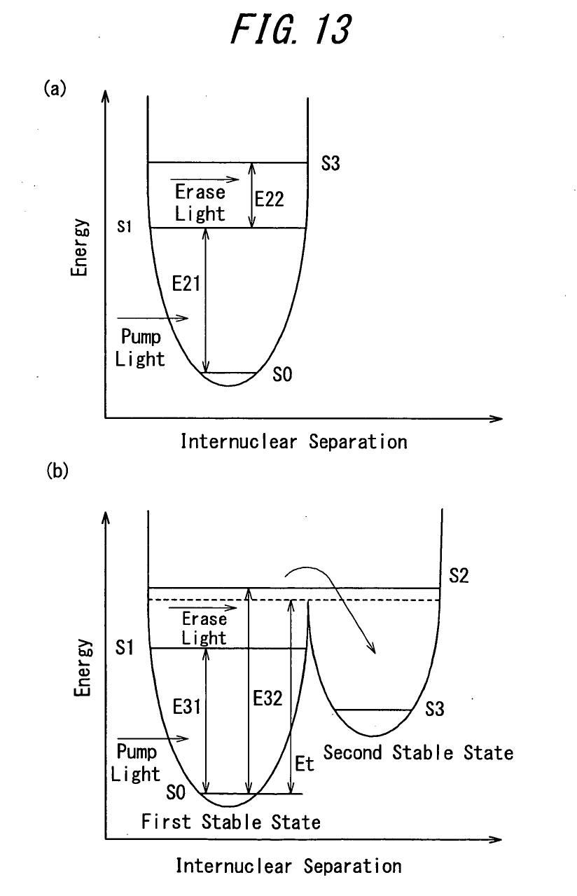

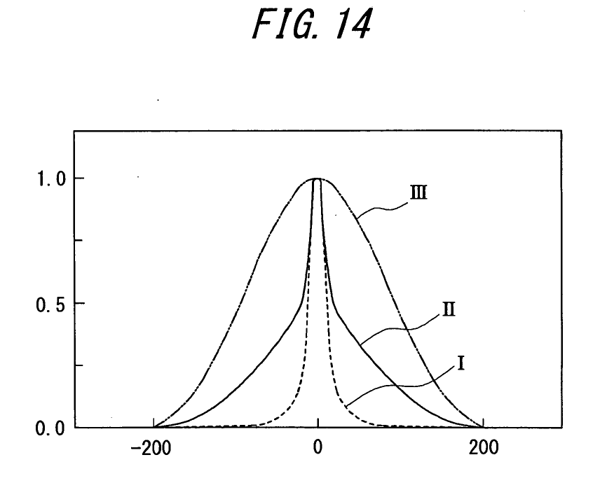

In the case of the sample containing the fluorescence protein FP595, the photon energy E1 required for exciting and transforming it from the S0 state to the first excited state S1 enabling the fluorescent emission as optical response is 2.2 eV taking into account the wavelength of the pump light. Meanwhile, the photon energy E32 (refer to FIG. 13 (b)) required for transformation from the first stable state (S0) beyond the barrier energy to the second stable state (S3) by the erase light only is 2.7 eV. Therefore, the light having photon energy of at least 2.7 eV can be utilized as erase light.

At this point, the difference in photon energy between the pump light and the erase light is 0.5 eV. Namely, assuming that the first excited state S1 is a criterion, the second excited state S2 exists as an energy level of 0.5 eV higher than the criterion. Generally, as in an electron state higher than the second excited state S2, energy states exist at close intervals and levels of vibration and rotation attributed thereto are widely dispersed or distributed, if molecules in the first excited state S1 are irradiated with the light having photon energy of 0.5 eV or more, it is possible to transform the molecules to the second stable state (S3) beyond the barrier energy Et. This amounts to 2.4 μm if it is converted into wavelengths.

Therefore, by using the light as an erase light having photon energy of 0.5 eV or more and 2.2 eV (photon energy of pump light) or less, the fluorescence protein FP595 in the first stable state (S0) can be excited to the first excited state S1, and further efficiently transformed to the second stable state (S3). In other words, if a light source generating light of wavelengths longer than 568 nm and shorter than 2.4 μm is selected, the light may be used as the erase light. As lasers enabling oscillation in such a wavelength region, for example, Ti: sapphire laser and popular near-infrared semiconductor lasers of various types have been known.

In the hitherto used super-resolving microscopy using only the double resonance absorption process, the laser beam having high leading value is required as an erase light source. Accordingly, extremely-short pulse laser beams of wavelengths of the order of picoseconds or femtoseconds have been converted in wavelength using various kinds of nonlinear crystals which are difficult to handle. As a result, microscope systems have become bulky and complicated, which are difficult to use for general biological users.

In contrast herewith, according to the super-resolving microscopy using the fluorescence protein FP595 in the present embodiment, even erase light having intensity of the order of μW can be used so that the range of choices of light sources becomes wider, and at the same time damage to biological samples can be reduced to a great extent.

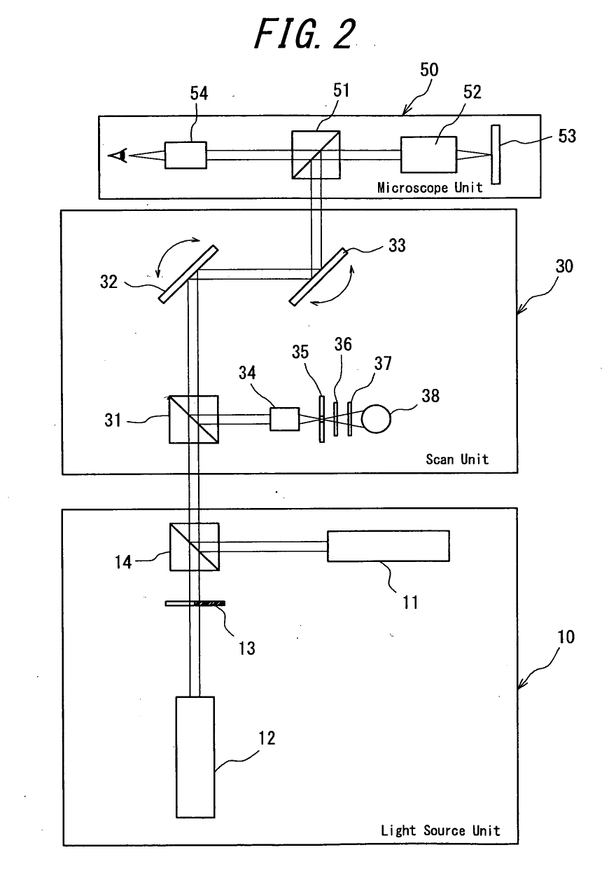

FIG. 2 is a block diagram of main parts of the optical system of the super-resolving microscope according to the present embodiment of the invention. This super-resolving microscope is based on the premise of the typical laser scanning fluorescence microscope and mainly comprises three independent units, that is, a light source unit 10, a scan unit 30, and a microscope unit 50.

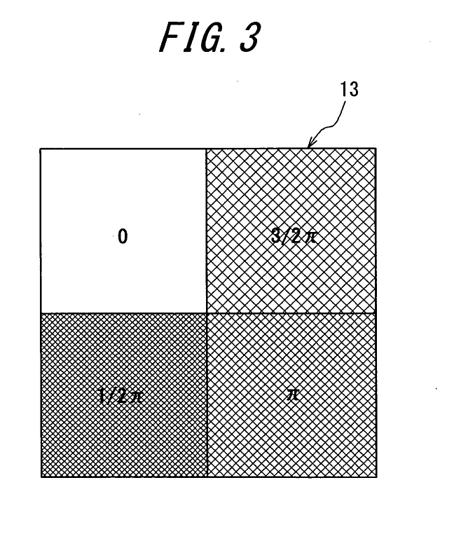

The light source unit 10 includes a first light source 11 consisting of an argon krypton laser for outputting pump light of, for example, wavelength 568 nm, a second light source 12 consisting of an Nd: YAG laser for outputting erase light of wavelength 1,064 nm, a phase plate 13 for modulating optical spaces of the erase light, and a beam combiner 14 for coaxially aligning the erase and pump lights with each other. The phase plate 13 is constructed by evaporating optical thin films adjusted in a manner that at a location where light axes are symmetrical, phases of erase light passing through the location are reversed as shown in the enlarged plan view of FIG. 3. As shown in FIG. 3, it has four independent regions about the optical axis, whose phases are different by ¼ with respect to the erase light wavelength. The light passing through the phase plate 13 is focused or concentrated so that electric fields are cancelled out on the optical axis to generate a hollow erase light.

The scan unit 30 operates in the following manner. The pump light and erase light commonly having the same optical axis and emitted from the light source unit 10 are caused to pass through a half mirror 31 and thereafter oscillated and scanned in two dimensional directions by two galvano mirrors 32 and 33 and emitted onto the microscope unit 50 (later described). Further, the fluorescence detected in the microscope unit 50 is advanced through the same pathway in reverse direction toward the half mirror 31 where the arrived fluorescence diverges. The diverged fluorescence is received in a photoelectron multiplier 38 through a projector lens 34, a pinhole 35, and notch filters 36 and 37. The galvano mirrors 32 and 33 are shown in a manner that as if they were able to oscillate in the same plane for the sake of simplicity in FIG. 2. In addition, the notch filters 36 and 37 serve to remove the pump and erase lights mixed in the fluorescence. Moreover, the pin hole 35 is an important optical element constituting a confocal optical system and serves to permit only the fluorescence emitted at a specified cross-section in a sample to pass therethrough.

The microscope unit 50 is a so-called fluorescence microscope typically used and operates in a manner that the pump and erase lights incident from the scan unit 30 are reflected on a half mirror 51 and focused through an objective lens 52 on the sample 53 containing fluorescence protein FP595. Further, the fluorescence emitted at the sample 53 is collimated at the objective lens 52 again and reflected at the half mirror 51 so as to be restored into the scan unit 30, and at the same time part of the fluorescence passing through the half mirror 51 is conducted to an eyepiece 54 so that the fluorescence can be visually observed as fluorescent image.

In the present embodiment, the sample 53 is scanned, while the sample 53 is continuously irradiated with the pump and erase lights so that the central part of the hollow erase light as observed region of the fluorescence is observed at super-resolution. In the illustrated embodiment, therefore, the sample 53 is scanned in synchronism with the time at which the region transformed to the second stable state by irradiating with the erase light is restored to the first stable state by thermal relaxation.

### Second Embodiment

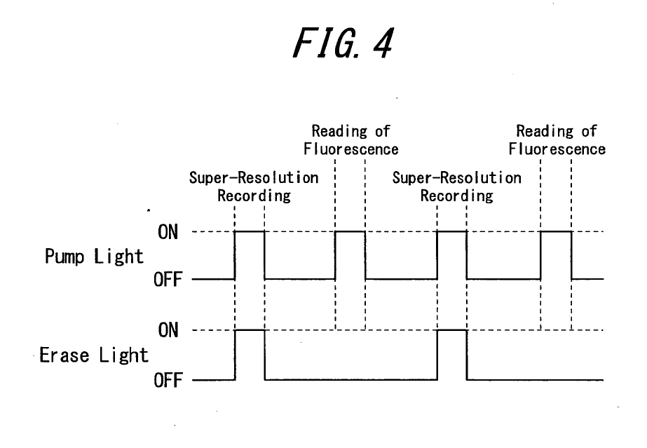

In the second embodiment of the invention, noticing the length of life time upon the fluorescence protein FP595 being transformed, a sample 53 is irradiated in pulse mode with the pump light from the first light source 11 and the erase light from the second light source 12 of the super-resolution microscope of the first embodiment with timing shown in FIG. 4.

More specifically, first, the respective points of the sample 53 to be observed are irradiated with the pump and erase lights at a time so that the molecules in the regions not required to detect signals are transformed to the second stable state (super-resolution recording), and then before restoring from the second stable state to the first stable state by thermal relaxation, the sample is irradiated with the pump light only, thereby reading out the fluorescence from the fluorescence protein FP595 in the first stable state positioned in a narrow region less than the diffraction limit in synchronism with the irradiation of the pump light only.

In this way, as the fluorescent signals are measured when the pump light only is irradiated according to the present embodiment, scattering lights of the erase light are not mixed therein so that the sample 53 can be observed at a super-resolution with a good S/N ratio.

Moreover, the pump light and erase light in pulse mode may be obtained by controlling the driving of the first and second light sources 11 and 12 to turn on and off their emitted lights themselves. Or the first and second light sources 11 and 12 may be caused to emit the pump and erase lights of CW, respectively, and intensity modulating means consisting of electrooptic and acoustooptic modulating elements and the like may be arranged in the light paths between the beam combiner 14 and the first and second light sources 11 and 12 to control the driving of the corresponding intensity modulating means, thereby obtaining the pump and erase lights in pulse mode.

### Third Embodiment

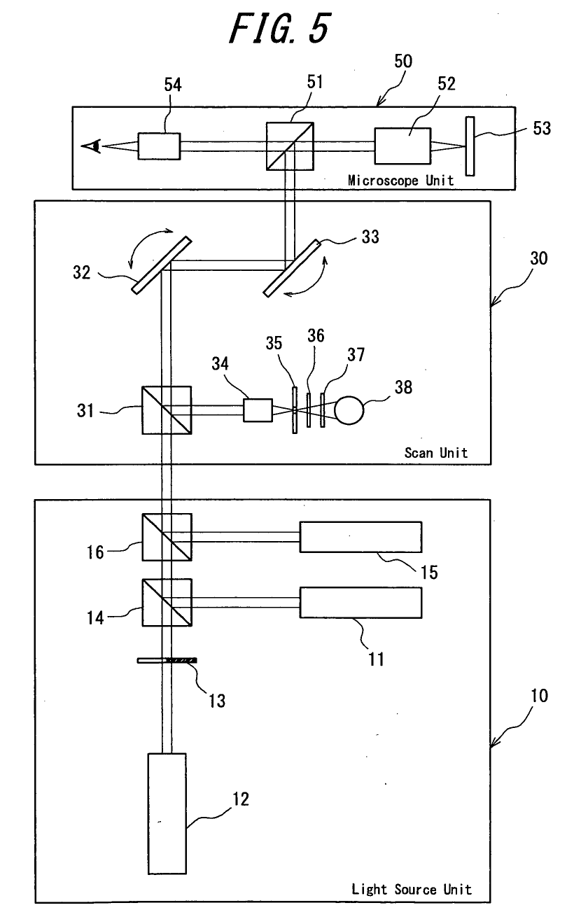

FIG. 5 is a block diagram of main parts of the optical system of the super-resolving microscope according to the third embodiment of the invention. In the embodiment, added to the light source unit 10 of the configuration shown in FIG. 2 are a third light source 15 adapted to emit third light (return light) which accelerates the returning of the fluorescence protein FP595 from the second stable state to the first stable state, and a beam combiner 16 for causing the optical axis of the return light from the third light source 15 to coincide with the optical axes of the pump and erase lights and for causing the return light to be fed into the scan unit 30. Other components of the optical system are substantially the same as those in FIG. 2.

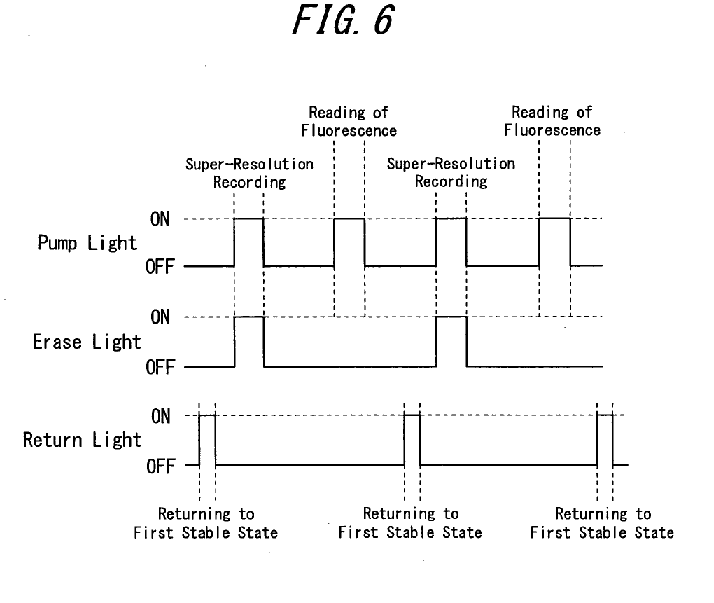

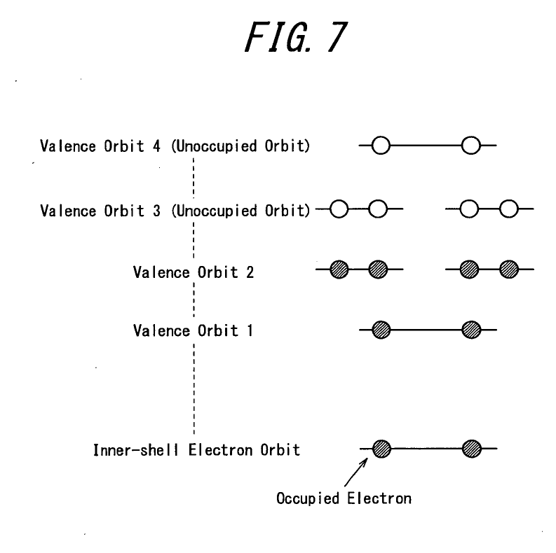

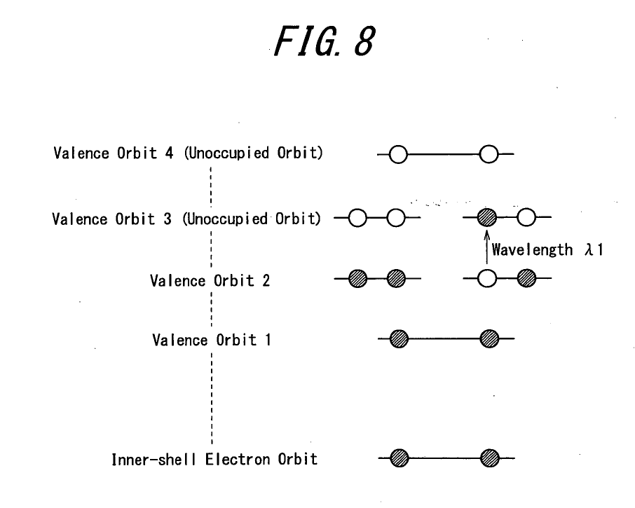

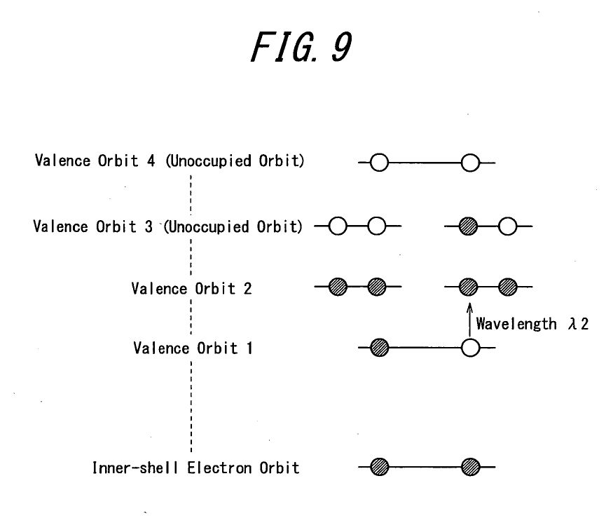

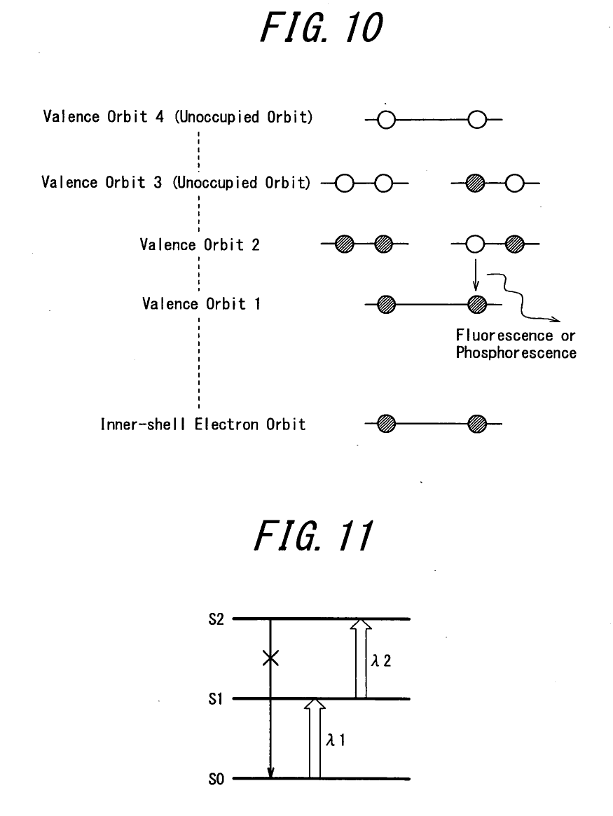

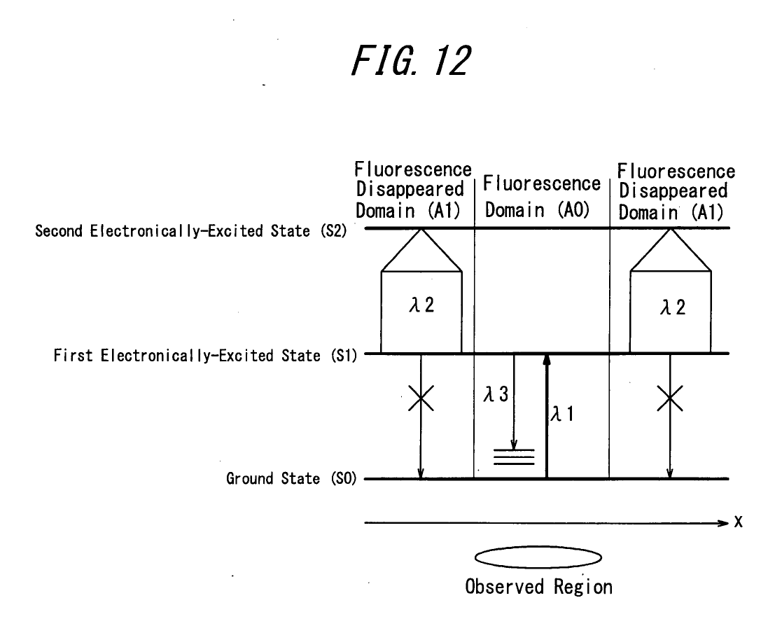

In the illustrated embodiment, the pump light from the first light source 11, the erase light from the second light source 12, and the return light from the third light source 15 are irradiated onto the sample 53 in pulse mode with the timing shown in FIG. 6. Namely, in the same manner as in the second embodiment shown in FIG. 4, first, the respective points of the sample 53 to be observed are irradiated with the pump and erase lights at a time so that the molecules in the regions not required to detect signals are transformed to the second stable state (super-resolution recording), and then before restoring from the second state to the first stable state by thermal relaxation, the sample is irradiated with the pump light only, thereby reading out the fluorescence from the fluorescence protein FP595 in the first stable state positioned in a narrow region less than the diffraction limit in synchronism with the irradiation of the pump light only. Thereafter, the points of the sample to be observed in which the super-resolution measurement has been completed are irradiated with the return light from the third light source 15 to accelerate the returning from the second stable state to the first stable state.

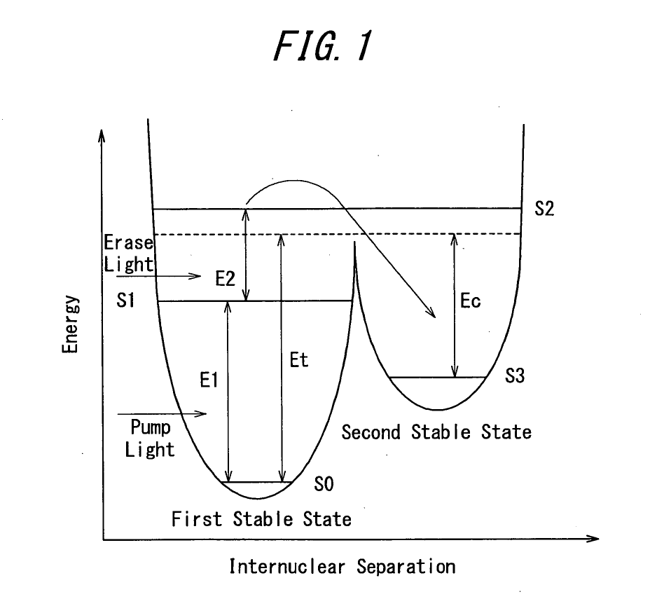

Similarly to the case that the pump and erase lights in pulse mode are obtained, here, the return light in pulse mode may be obtained by controlling the driving of the third light source 15 to turn on and off their emitted lights themselves, or the third light source 15 is caused to emit the return light of CW, and intensity modulating means may be arranged in the light path between the beam combiner 16 and the third light source 15 to control the driving of the intensity modulating means, thereby obtaining the return light in pulse mode. Moreover, the return light emitted from the third light source 15 has wavelengths shorter than those of the erase light emitted from the second light source 12, and has photon energy larger than the barrier energy Ec (refer to FIG. 1) for causing the fluorescence protein FP595 to return from the second stable state to the first stable state.

According to the embodiment of the invention, in this way, the observed point of the sample 53 in which the super-resolution measurement has been completed is irradiated with the return light from the third light source 15 to accelerate the returning of the fluorescence protein FP595 from the second stable state to the first stable state. In addition to the effects of the second embodiment, therefore, the returning to the first stable state can be accelerated, with the result that the scanning of the sample 53 can be rapidly carried out to achieve marked shortening of measuring time.

Although the observation of samples containing the fluorescence protein FP595 has been explained by way of example in the above embodiments, the invention is not to be limited to the observation of samples containing fluorescence protein FP595, but is effectively applicable to observation of samples containing other photochromic molecules. In such a case, the first light (pump light), the second light (erase light), and the third light (return light) may be suitably set depending on optical characteristics of the photochromic molecules.

### INDUSTRIAL APPLICABILITY

According to the invention, samples containing photochromic molecules can be observed by securely inducing the fluorescence-suppression effect without producing any residual fluorescent components so that an image formation capability can be obtained which is in no way inferior as compared with the super-resolving microscopy utilizing the double resonance absorption process of the prior art. With the super-resolving microscopy utilizing the double resonance absorption process of the prior art, moreover, the nonfluorescence relaxation process includes only the path of thermal relaxation. In contrast herewith, according to the invention, as the photochromic light response participates in the nonfluorescence relaxation process in the case of photochromic molecules, the fluorescence-suppression can be realized by means of weak second light (erase light), while the damage to biological samples can be greatly reduced. As a result, the invention can provide microscopes as commercial goods which have the high performance as super-resolving microscopes and are simple in system configuration.

1. A method for observing a sample containing photochromic molecules having a quantum state of at least a first stable state S0 and a second stable state S3, wherein first light and second light are used, said first light for exciting said photochromic molecules from said first stable state S0 to a first excited state S1 enabling optical response, and said second light for exciting said photochromic molecules from said first excited state S1 to a second excited state S2 of another energy level, and
wherein said sample is irradiated with said first light and said second light partly overlapping each other so that said photochromic molecules in the region irradiated with said overlapping first and second lights are transformed through said second excited state S2 to said second stable state S3, and said photochromic molecules in the region irradiated with said first light only are transformed to said first excited state S1, thereby observing said sample.

2. A microscope for observing a sample containing photochromic molecules having a quantum state of at least a first stable state S0 and a second stable state S3,
said microscope comprising:
a first light source for emitting first light for exciting said photochromic molecules from said first stable state S0 to a first excited state S1 enabling optical response,
a second light source for emitting second light for exciting said photochromic molecules from said first excited state S1 to a second excited state S2 of another energy level,
an optical system for partly overlapping said first light and said second light and focusing the overlapping lights on said sample so as to irradiate said sample with the overlapping lights,
a scan section for scanning said sample by relatively moving said sample and the lights emitted through said optical system so that said photochromic molecules in the region irradiated with said overlapping first and second lights by said optical system are transformed through said second excited state S2 to said second stable state S3, and said photochromic molecules in the region irradiated with said first light only are transformed to said first excited state S1, and
a detecting section for detecting optical response generated from said photochromic molecules excited to said first excited state S1.

3. The microscope as claimed in claim 2, wherein the following relation is satisfied;
E2<E1<Et<E1+E2, and E1<Ec
where E1: photon energy of said first light, E2: photon energy of said second light, Et: barrier energy when said photochromic molecules are transformed from said first stable state S0 to said second stable state S3, and Ec: barrier energy when said photochromic molecules are transformed from said second stable state S3 to said first stable state S0.

4. The microscope as claimed in claim 2, wherein irradiation timing of said first light and said second light is so controlled that the irradiation of said second light is started, while relaxation of said photochromic molecules exited to said first excited state S1 by the irradiation of said first light has not started yet.

5. The microscope as claimed in claim 2, wherein irradiation timing of said first light and said second light is so controlled that at respective points to be observed said first light and said second light are irradiated and then said first light only is irradiated, and
wherein the optical response generated from said photochromic molecules by the irradiation of said first light only is detected in said detecting section.

6. The microscope as claimed in claim 2, wherein said microscope further comprises a third light source for emitting third light having photon energy larger than barrier energy Ec when said photochromic molecules are transformed from said second stable state S3 to said first stable state S0, and after the detection of the optical response generated from said photochromic molecules at respective points to be observed, said respective points are irradiated with said third light through said optical system to restore said photochromic molecules in said second stable state S3 to said first stable state S0.

7. The microscope as claimed in claim 3, wherein irradiation timing of said first light and said second light is so controlled that the irradiation of said second light is started, while relaxation of said photochromic molecules excited to said first excited state S1 by the irradiation of said first light has not started yet.

8. The microscope as claimed in claim 3, wherein irradiation timing of said first light and said second light is so controlled that at respective points to be observed said first light and said second light are irradiated and then said first light only is irradiated, and
wherein the optical response generated from said photochromic molecules by the irradiation of said first light only is detected in said detecting section.

9. The microscope as claimed in claim 3, wherein said microscope further comprises a third light source for emitting third light having photon energy larger than barrier energy Ec when said photochromic molecules are transformed from said second stable state S3 to said first stable state S0, and after the detection of the optical response generated from said photochromic molecules at respective points to be observed, said respective points are irradiated with said third light through said optical system to restore said photochromic molecules in said second stable state S3 to said first stable state S0.

10. The microscope as claimed in claim 4, wherein irradiation timing of said first light and said second light is so controlled that at respective points to be observed said first light and said second light are irradiated and then said first light only is irradiated, and
wherein optical response generated from said photochromic molecules by the irradiation of said first light only is detected in said detecting section.

11. The microscope as claimed in claim 4, wherein said microscope further comprises a third light source for emitting third light having photon energy larger than barrier energy Ec when said photochromic molecules are transformed from said second stable state S3 to said first stable state S0, and after the detection of the optical response generated from said photochromic molecules at respective points to be observed, said respective points are irradiated with said third light through said optical system to restore said photochromic molecules in said second stable state S3 to said first stable state S0.

12. The microscope as claimed in claim 5, wherein said microscope further comprises a third light source for emitting third light having photon energy larger than barrier energy Ec when said photochromic molecules are transformed from said second stable state S3 to said first stable state S0, and after the detection of the optical response generated from said photochromic molecules at respective points to be observed, said respective points are irradiated with said third light through said optical system to restore said photochromic molecules in said second stable state S3 to said first stable state S0.
